(19) United States
(12) Patent Application Publication
(10) Pub. No.: US 2007/0185610 A1
(43) Pub. Date: Aug. 9, 2007

(54) Robot system and method for the application of dislodging material and pin positioning in casting wheels

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/598,143

(22) Filed: Nov. 13, 2006

Related U.S. Application Data
(60) Provisional application No. 60/734,983, filed on Nov. 10, 2005.

(51) Int. Cl. B29C 39/00

(52) U.S. Cl. 700/197

(57) ABSTRACT

At present, the tasks associated to the application of dislodging material and/or repositioning of anode lifting pins from casting wheels are characterized by the exposure of the personnel to harsh environmental conditions. In the medium and long term, this could generate serious occupational diseases to the personnel in charge of carrying out this task. Due to the above, a robotic method and system have been developed for the application of dislodging material and/or verification of anode lifting pins from casting wheels. The robotic system is composed mainly of a robotic manipulator of at least 5 degrees of freedom which is mounted on a fixed and/or mobile system, and a gripping mechanism which allows to take a vision system to be used in the cast inspection process of the casting wheel. Once this is done, the gripping mechanism takes a device to be used for the dislodging material application before the metal discharge is carried out through the channel to the refine furnace. Finally, the gripping mechanism takes a tool which is used to position the pins in the cast. In this regard, most of the problems associated to the safety of the people and the productivity of the current manual and/or mechanical process are eliminated.

### CROSS-REFERENCE TO RELATED APPLICATIONS

This application claims the benefit of provisional patent application Ser. No. 60/734,983 filed 2005 Nov. 10 by the present inventor

### FEDERAL SPONSORED RESEARCH

Not Applicable

### SEQUENCE LISTING OR PROGRAM

Not Applicable

### BACKGROUND-FIELD OF INVENTION

This invention relates to the use of robotic technology in mining industry to improve the working conditions of the operators and operating conditions of the casting wheels specifically in the smelting area.

### BACKGROUND-PRIOR ART

During metal obtention and refining processes, smelting furnaces are used to cast metal concentrates for purifying and extracting them. The first stage of the productive process is to move the dry concentrate to one of these furnaces, which could be a flash furnace and/or a Teniente converter, where casting is at temperatures over 1,200° C. In this way, while the concentrate becomes molten liquid, its components are being separated and combined to form a two layer bath. The heaviest layer is called matte and it is a metal enriched component. Over this layer, the slag is floating, which is a coat of impurities of the metal of interest. In this way and during successive stages, the stage rich in the metal of interest is sequentially cast and refined through several furnaces which allows to obtain a high purity metal.

In the last stage of the smelting process, the fire refining stage is carried out in which the metal is processed in rotary furnaces, by adding special purifying agents which are called fluidizing agents to oxide and eliminate all the impurities with the resulting effect of very few non desired elements contained in the molten bath. Then, the oxygen is extracted with steam or oil injections with the final result of a high purity level.

Thus, when a metal load reaches the required purity level, the furnace is inclined and in exact quantities the metal is poured in one of the ingot casts of the fire refined casting wheel. Once the metal is poured into the cast, the wheel rotates to advance the following cast to the position and other ingot is cast. In this way, the wheel speed is adjusted in an accurate way to the optimum speed profile, ensuring a smooth acceleration and disacceleration level of the casts. This is intended to produce high quality anodes with a minimum burr formation grade.

To finish the smelting process, the cast removal process (stripping and/or extraction) proceeds in which the anodes are lifted and sent to a cooling tank to avoid the excessive oxidation and to obtain a deep scrubbing.

Finally, the cast anodes are counted and arranged in predetermined bundles or arranged at distances as required by the electrolytic plant. The discharge of the cooling tanks is carried out by a forklift or anode lifting devices.

One of the major disadvantages of the tasks associated to the casting and removal of the anodes from the casting wheels is the exposure of the personnel to harsh environmental conditions. In the medium and long term this could generate serious occupational diseases to the people in charge of carrying out this task.

Specifically in the processes to apply dislodging material, there are some disadvantages from the point of view of safety as a result of the exposition to spatters and/or projections of molten metal. Similarly, the manipulation of the tool used by the operator in these tasks must be carried out with extreme care for not damaging the surface of the cast. On the other hand, from the operations point of view, the pins should be correctly positioned to avoid the infiltration of copper because when lifting the anode the surface could be damaged, generating a decrease in the production capacity.

### SUMMARY

A robotic system and a robotized method have been developed for for the application of dislodging material and the repositioning of pins in the casts of the casting wheels, allowing to carry out necessary tasks in a automated way. These tasks are: Dislodging material application and verification of pins in the casting wheel

### DRAWINGS—FIGURES

In the drawings, closely related figures share the same numbers, with different alphabetic suffixes.

FIG. 1. View of the application of dislodging material procedure in the casting wheel.

FIG. 2. View of the verification process of pins and its correction

### DRAWINGS—REFERENCE NUMERALS

1. Robotic manipulator

2. Mobile or fixed mounting system

3. Gripping mechanism

4. Vision system

5. Casting wheel

6. Dislodging application tool

7. Dislodging material

8. Metal discharge

9. Channel

10. Refine furnace

11. Repositioning pin tool

### DETAILED DESCRIPTION

This invention relates to a new robot system as well as a robotic method for the dislodging material application and verification of pins in the casting wheel which are carried out automatically through anthropomorphous robotic arms of at least 4 degrees of freedom, provided with a gripping mechanism, so as the robotic system y designed to manipulate several tools and/or vision systems and allows to carry out the following activities:
To take a tool with a vision system which allows to carry out the inspection procedure of the cast in the casting wheel.
To take a tool to carry out the dislodging procedure in the casting wheel.
To take a tool to carry out the repositioning of pins in the casting wheel.

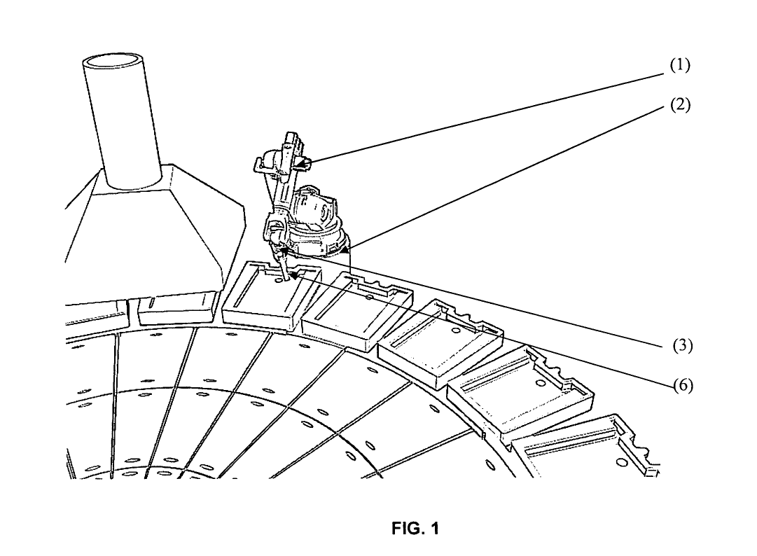

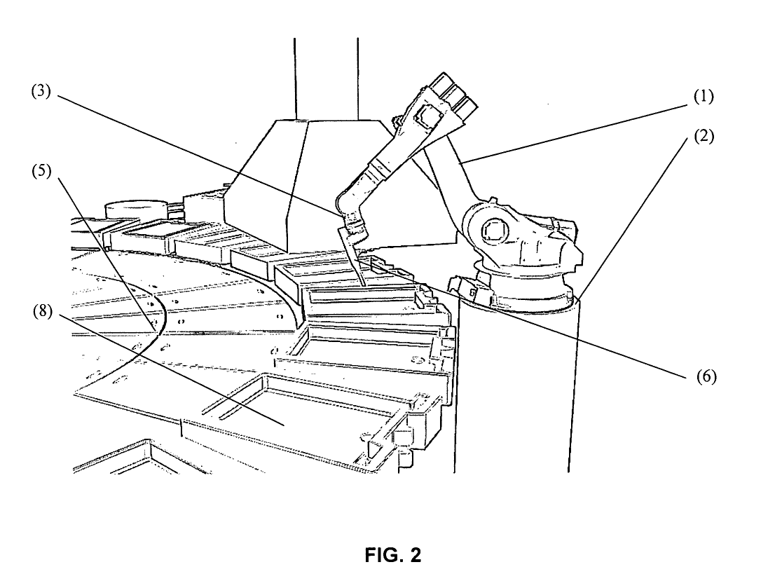

With reference to FIGS. 1 and 2, the robot system is composed mainly of one robotic manipulator (1) of at least 4 degrees of freedom, provided with a communication, acquisition and control system, so as the manipulator is mounted on a fixed or mobile system (2), and is provided with a gripping mechanism (3) to allow to take a vision system (4) to be used in the cast inspection process in the casting wheel (5). Once this is done, the gripping mechanism (3) takes the tool (6) which will be used in the dislodging material application (7) before the metal discharge (8) through the channel (9) of the refine furnace (10). Finally the gripping mechanism (3) takes a tool (11) which is used to carry out the repositioning of the pin in the casting wheel (5).

I claim

1. A robot system for the application of dislodging material and the repositioning of pins in the casts of the casting wheels comprising an anthropomorphous robotic arm of at least 4 degrees of freedom, one control, communication and programming unit, one gripper adapter, one pneumatic gripper, its fingers, one pneumatic gripper driving system, one electric supply system and a fixed or mobile tool holder wherein the anthropomorphous robotic arm of at least 4 degrees of freedom is provided with a pneumatic gripping mechanism which allows in a sequential and programmed way to take, manipulate and release several tools and/or vision systems which are deposited in a fixed and/or mobile tool holder located near the robotic manipulator which are used for the inspection of the cast, the application of dislodging material and the repositioning of pins in the casts of casting wheels.

2. A robot system for the application of dislodging material and the repositioning of pins in the casts of the casting wheels according to claim 1, wherein a tool holder is used from which the robotic manipulator takes the vision system so as to move it through a defined path to the working area in which the inspection of the cast in the casting wheel will take place.

3. A robot system for the application of dislodging material and the repositioning of pins in the casts of the casting wheels according to claim 1, wherein a tool holder is used from which the robotic manipulator takes a tool so as to move to through a defined path to the working area in which a dislodging material application will take place to the casting wheel.

4. A robot system for the application of dislodging material and the repositioning of pins in the casts of the casting wheels according to claim 1, wherein the anthropomorphous robotic manipulator could communicate by itself or through a PLC interface with the control system.

5. A robot system for the application of dislodging material and the repositioning of pins in the casts of the casting wheels according to claim 1, wherein the anthropomorphous robotic manipulator has the capacity to obtain and interpret the information from installed analogue and/or digital sensors.

6. A robot system for the application of dislodging material and the repositioning of pins in the casts of the casting wheels according to claim 1, wherein the anthropomorphous robotic manipulator has the capacity to generate analogue and/or digital signals to control analogue and/or digital input devices.

7. A robot system for the application of dislodging material and the repositioning of pins in the casts of the casting wheels according to claim 1, wherein a tool holder is used from which the robotic manipulator takes a tool so as to move it through a defined path to the working area in which the repositioning of pins in the casts of the casting wheel will take place.

8. A robot system for the application of dislodging material and the repositioning of pins in the casts of the casting wheels according to claim 1, wherein the robotic manipulator may use a pneumatic, electric and/or hydraulic gripping mechanism which allows to take, manipulate and release several tools and/or vision systems to be used according to the task to be performed.

9. A robot system for the application of dislodging material and the repositioning of pins in the casts of the casting wheels according to claim 1, wherein the anthropomorphous robotic manipulator has an electrical system driven by three-stage induction motors, with vectorial and/or scalar control.

10. A robot system for the application of dislodging material and the repositioning of pins in the casts of the casting wheels according to claim 1, wherein it has the capacity to move and manipulate several tools and/or vision systems in different paths within the work volume of the robotic manipulator.

11. A robot system for the application of dislodging material and the repositioning of pins in the casts of the casting wheels according to claim 1, wherein it has the capacity to move and manipulate several tool in different paths within the work volume of the robotic manipulator.

12. A robot system for the application of dislodging material and the repositioning of pins in the casts of the casting wheels according to claim 1, wherein it could be integrated to the anode dislodging process in any type of smelting furnace whether in smelting and/or conversion processes of copper and other metals such as (iron, zinc, nickel, silver, gold, tin, lead, etc.).

13. A robot system for the application of dislodging material and the repositioning of pins in the casts of the casting wheels according to claim 1, wherein the system may operate automatically, or semiautomatically, and also allows solutions scalability.

14. A robotic method for the application of dislodging material and the repositioning of pins in the casts of the casting wheels using the robot System of claim 1 to 13, wherein the robotic manipulator anthropomorphous of at least 4 degrees of freedom is provided with a pneumatic gripping mechanism which allows in a sequential and programmed way to take, manipulate and release several tools and/or vision systems which are deposited in a fixed and/or mobile tool holder located near the robotic manipulator which are used for the inspection of the cast, the application of dislodging material and the repositioning of pins in the casts of casting wheels.

15. A robotic method for the application of dislodging material and the repositioning of pins in the casts of the casting wheels using the robot System of claim 1 to 13, wherein the anthropomorphous robotic manipulator could communicate by itself or through a PLC interface with the control system.

16. A robotic method for the application of dislodging material and the repositioning of pins in the casts of the casting wheels using the robot System of claim 1 to 13, wherein the anthropomorphous robotic manipulator has the capacity to obtain and interpret the information from installed analogue and/or digital sensors.

17. A robotic method for the application of dislodging material and the repositioning of pins in the casts of the casting wheels using the robot System of claim 1 to 13, wherein the anthropomorphous robotic manipulator has the capacity to generate analogue and/or digital signals to control the analogue and/or digital inputs devices.

18. A robotic method for the application of dislodging material and the repositioning of pins in the casts of the casting wheels using the robot System of claim 1 to 13, wherein a tool holder is used from which the robotic manipulator takes the vision system so as to move it through a defined path to the working area in which the inspection of the cast in the casting wheel will take place.

19. A robotic method for the application of dislodging material and the repositioning of pins in the casts of the casting wheels using the robot System of claim 1 to 13, wherein a tool holder is used from which the robotic manipulator takes a tool so as to move to through a defined path to the working area in which a dislodging material application will take place to the casting wheel.

20. A robotic method for the application of dislodging material and the repositioning of pins in the casts of the casting wheels using the robot System of claim 1 to 13, wherein a tool holder is used from which the robotic manipulator takes a tool so as to move it through a defined path to the working area in which the repositioning of pins in the casts of the casting wheel will take place.

21. A robotic method for the application of dislodging material and the repositioning of pins in the casts of the casting wheels using the robot System of claim 1 to 13, wherein the robotic manipulator may use a pneumatic, electric and/or hydraulic gripping mechanism which allows to take, manipulate and release several tools and/or vision systems to be used according to the task to be performed.

22. A robotic method for the application of dislodging material and the repositioning of pins in the casts of the casting wheels using the robot System of claim 1 to 13, wherein the anthropomorphous robotic manipulator has an electrical system driven by three-stage induction motors with vectorial and/or scalar control.

23. A robotic method for the application of dislodging material and the repositioning of pins in the casts of the casting wheels using the robot System of claim 1 to 13, wherein it has the capacity to move and manipulate several tools and/or vision systems in different paths within the work volume of the robotic manipulator.

24. A robotic method for the application of dislodging material and the repositioning of pins in the casts of the casting wheels using the robot System of claim 1 to 13, wherein it has the capacity to move and manipulate several tool in different paths within the work volume of the robotic manipulator.

25. A robotic method for the application of dislodging material and the repositioning of pins in the casts of the casting wheels using the robot System of claim 1 to 13, wherein it could be integrated to the anode dislodging process in any type of smelting furnace whether in smelting and/or conversion processes of copper and other metals such as (iron, zinc, nickel, silver, gold, tin, lead, etc.).

26. A robotic method for the application of dislodging material and the repositioning of pins in the casts of the casting wheels using the robot System of claim 1 to 13, wherein the system may operate automatically or semiautomatically, and also allows solution scalability.

27. A tool or device for the application of dislodging material in the casts of the casting wheels using the robot System of claim 1 to 13, wherein a tool is used which is located in the tool holder so as the robotic manipulator takes it in a sequential and programmed way to carry out the application of dislodging material in the casts of the casting wheels so as once this is done it deposits the tool back into the tool holder.

28. A tool or device for the repositioning of pins in the casts of the casting wheels using the robot system of claim 1 to 13, wherein a tool is used which is located in the tool holder so as the robotic manipulator takes it in a sequential and programmed way to carry out the repositioning of pins in the casts of the casting wheel so as once this is done it deposits the tool back into the tool holder
